(19) United States
(12) Patent Application Publication
(10) Pub. No.: US 2024/0174070 A1
(43) Pub. Date: May 30, 2024

(54) VIBRATION DAMPING DEVICE

(71) Applicant: Sumitomo Riko Company Limited, Aichi (JP)

(72) Inventor: Taiki Kouketsu, Aichi (JP)

(73) Assignee: Sumitomo Riko Company Limited, Aichi (JP)

(21) Appl. No.: 18/489,832

(22) Filed: Oct. 18, 2023

(30) Foreign Application Priority Data
Nov. 30, 2022 (JP) 2022-191915

(51) Int. Cl. B60K 5/12

(52) U.S. Cl. CPC B60K 5/1208

(57) ABSTRACT

In a vibration damping device in which a separate stopper member is accommodated in an accommodation recess opening in an axial direction, a retaining part protruding toward an inner circumference is provided at an opening of the accommodation recess. The stopper member having a substantially quadrilateral outer shape is provided with lip-shaped parts protruding from the corner portions toward the outer circumference, and the lip-shaped part is located in the accommodation recess further inward than the retaining part and overlaps the retaining part in the axial projection. A rod insertion hole is formed through the stopper member in the axial direction, and a pair of facing side portions on an outer circumferential surface of the stopper member are spaced apart from an inner circumferential surface of the accommodation recess to an inner circumference in a region extending to both outer sides of the rod insertion hole between the lip-shaped parts.

### CROSS-REFERENCE TO RELATED APPLICATION

This application claims the priority benefit of Japan application serial no. 2022-191915, filed on Nov. 30, 2022. The entirety of the above-mentioned patent application is hereby incorporated by reference herein and made a part of this specification.

### BACKGROUND

### Technical Field

The disclosure relates to a vibration damping device used for an automobile engine mount or the like, and more particularly to a vibration damping device equipped with a separate stopper member that limits an amount of relative displacement between a first mounting member and a second mounting member in a direction perpendicular to an axis.

### Description of Related Art

Conventionally, a vibration damping device is known as a type of vibration damping connecting body or vibration damping support that is interposed between members constituting a vibration transmission system and connects the members to each other in a vibration damping manner. For example, as shown in Japanese Patent No. 5543047 (Patent Document 1), a vibration damping device has a structure in which a first mounting member mounted on one member constituting a vibration transmission system and a second mounting member mounted on another member constituting the vibration transmission system are elastically connected to each other by a main rubber elastic body.

Further, an accommodation recess is formed on the inner circumferential side of the second mounting member, a separate stopper member is disposed in the accommodation recess, and an amount of relative displacement between the first mounting member and the second mounting member in a direction perpendicular to an axis is limited by contact via the stopper member.

Incidentally, in the vibration damping device described in Patent Document 1, the stopper member needs to be held without falling out of the accommodation recess in the vibration damping device alone before being mounted in a vehicle or the like. In Patent Document 1, an elastic tapered part is provided at an opening of the accommodation recess as a retaining part that is inclined inwardly toward the opening side, and a stopper protrusion of the stopper member protruding toward the outer circumference overlaps the elastic tapered part in axial projection in a state in which the stopper protrusion is inserted deeper inwardly than the elastic tapered part. Thus, the engagement between the stopper protrusion and the elastic tapered part prevents the stopper member from falling out of the accommodation recess and holds the stopper member in the accommodation recess.

However, in Patent Document 1, for example, as shown in FIGS. 2 and 3, the stopper protrusion of the stopper member may be in contact with an inner circumferential surface of the accommodation recess, and in this case, the stopper member affects spring properties in a direction perpendicular to the axis (the left-right direction in FIGS. 2 and 3) which is a front-rear direction of a vehicle, and a spring of the vibration damping device in the front-rear direction of the vehicle becomes hard. As a result, it was thought that vibration damping performance such as a vibration isolation action against idling vibration would be adversely affected.

### PATENT DOCUMENTS

[Patent Document 1] Japanese Patent No. 5543047

The disclosure provides a vibration damping device with a new structure that can stably hold a separate stopper member in an accommodation recess even before it is mounted in a vehicle or the like while an influence of the stopper member on vibration damping performance is controlled.

### SUMMARY

An aspect of the disclosure provides vibration damping device in which a first mounting member and a second mounting member are connected by a main rubber elastic body, and a separate stopper member is accommodated in an accommodation recess that opens in an axial direction in an inner circumference of a tubular part of the second mounting member. A retaining part that protrudes toward an inner circumference is provided at an opening of the accommodation recess. An outer shape of the stopper member is substantially quadrilateral, and lip-shaped parts that protrude from corner portions toward an outer circumference are provided at the stopper member. The lip-shaped part is located further inward than the retaining part in the accommodation recess, and the lip-shaped part overlaps the retaining part in axial projection. A rod insertion hole through which a rod member fixed to the first mounting member is inserted is formed through the stopper member in the axial direction. A pair of facing side portions located on both sides in a direction perpendicular to an axis on an outer circumferential surface of the stopper member are spaced apart from an inner circumferential surface of the accommodation recess toward an inner circumference in a region extending to both outer sides of the rod insertion hole between the lip-shaped parts.

### BRIEF DESCRIPTION OF THE DRAWINGS

FIG. 1 is a plan view showing an engine mount as a first embodiment of the disclosure.

FIG. 2 is a bottom view of the engine mount shown in FIG. 1.

FIG. 3 is a cross-sectional view taken along line III-III in FIG. 1.

FIG. 4 is a cross-sectional view taken along IV-IV in FIG. 1.

FIG. 5 is a perspective view of a mount main body constituting the engine mount shown in FIG. 1.

FIG. 6 is a perspective view showing the mount main body shown in FIG. 5 from another perspective.

FIG. 7 is a longitudinal cross-sectional view of the mount main body shown in FIG. 5, corresponding to a cross section along line VII-VII of FIG. 8.

FIG. 8 is a bottom view of the mount main body shown in FIG. 7.

FIG. 9 is a cross-sectional view taken along line IX-IX of FIG. 8.

FIG. 10 is a perspective view of a stopper rubber constituting the engine mount shown in FIG. 1.

FIG. 11 is an enlarged plan view showing the stopper rubber in FIG. 10.

FIG. 12 is an enlarged front view showing the stopper rubber in FIG. 10.

FIG. 13 is an enlarged right side view showing the stopper rubber in FIG. 10.

FIG. 14 is a cross-sectional view taken along line XIV-XIV of FIG. 12.

FIG. 15 is an enlarged view of a part A of FIG. 2.

### DESCRIPTION OF THE EMBODIMENTS

Hereinafter, exemplary aspects for understanding the disclosure will be described, but each of the aspects described below is described as an example, and not only can the aspects be employed in combination with each other as appropriate, but also the plurality of components described in each of the aspects can be recognized and employed independently as far as possible, and the components can also be employed in combination with any of the components described in other aspects as appropriate. Thus, the disclosure can be implemented in various alternatives without being limited to the aspects described below.

According to a first aspect, there is provided a vibration damping device in which a first mounting member and a second mounting member are connected by a main rubber elastic body, and a separate stopper member is accommodated in an accommodation recess that opens in an axial direction in an inner circumference of a tubular part of the second mounting member, wherein a retaining part that protrudes toward an inner circumference is provided at an opening of the accommodation recess, an outer shape of the stopper member is substantially quadrilateral, and lip-shaped parts that protrude from corner portions toward an outer circumference are provided at the stopper member, the lip-shaped part is located further inward than the retaining part in the accommodation recess, and the lip-shaped part overlaps the retaining part in axial projection, a rod insertion hole through which a rod member fixed to the first mounting member is inserted is formed through the stopper member in the axial direction, and a pair of facing side portions located on both sides in a direction perpendicular to an axis on an outer circumferential surface of the stopper member are spaced apart from an inner circumferential surface of the accommodation recess toward an inner circumference in a region extending to both outer sides of the rod insertion hole between the lip-shaped parts.

According to the vibration damping device constructed according to this aspect, the stopper member having the lip-shaped part does not easily come out of the accommodation recess because the lip-shaped part located further inward than the retaining part provided on the inner circumferential surface of the opening of the accommodation recess is hooked on the retaining part in the axial direction. Therefore, in the vibration damping device in a single unit state before being mounted in a vehicle or the like, the stopper member is held in the accommodation recess, which facilitates transportation and management of the vibration damping device.

In the stopper member, the lip-shaped part protruding from the corner portion overlaps the retaining part in axial projection, and in the outer circumferential surface of the stopper member, the pair of facing side portions located on both sides in the direction perpendicular to the axis between the lip-shaped parts in the circumferential direction is separated from the inner circumferential surface of the accommodation recess. Thus, in the direction perpendicular to the axis in which the pair of facing side portions are located, the stopper member is less likely to affect spring properties of the vibration damping device, and low spring properties can be easily realized in the direction perpendicular to the axis. Moreover, since the pair of facing side portions of the stopper member and the inner circumferential surface of the accommodation recess are spaced apart from each other over a wide range that extends to both outer sides of the rod insertion hole, the low spring properties in the direction perpendicular to the axis are effectively achieved due to the spacing between the pair of facing side portions and the inner circumferential surface of the accommodation recess.

According to a second aspect, in the vibration damping device described in the first aspect, another pair of facing side portions located between the pair of facing side portions on the outer circumferential surface of the stopper member in a circumferential direction may be in contact with the inner circumferential surface of the accommodation recess.

According to the vibration damping device constructed according to this aspect, in two directions perpendicular to the axis that are substantially orthogonal to each other, the low spring properties due to the spacing between the outer circumferential surface of the stopper member and the inner circumferential surface of the accommodation recess, and high spring properties due to the contact between the outer circumferential surface of the stopper member and the inner circumferential surface of the accommodation recess are achieved. Therefore, it is possible to set a large spring ratio in the two directions perpendicular to the axis, and to obtain a large degree of freedom in tuning the spring properties.

According to a third aspect, in the vibration damping device described in the first or second aspect, a magnitude of curvature of the pair of facing side portions of the stopper member may be smaller than a magnitude of curvature of a portion of the inner circumferential surface of the accommodation recess that faces the pair of facing side portions.

According to the vibration damping device constructed according to this aspect, for example, even when both the pair of facing side portions of the stopper member and the inner circumferential surface of the accommodation recess are curved surfaces that are concave or convex toward the inner circumference side, due to the difference in curvature, the pair of facing side portions of the stopper member and the inner circumferential surface of the accommodation recess can be spaced apart from each other.

According to a fourth aspect, in the vibration damping device described in the third aspect, the pair of facing side portions of the stopper member may be planar, and the portion of the inner circumferential surface of the accommodation recess that faces the pair of facing side portions may be formed of a curved surface that is concave toward the inner circumference.

According to the vibration damping device constructed according to this aspect, due to the difference in shape between the pair of facing side portions of the stopper member and the inner circumferential surface of the accommodation recess, the pair of facing side portions and the inner circumferential surface of the accommodation recess can be more reliably spaced apart from each other.

According to a fifth aspect, in the vibration damping device described in any one of the first to fourth aspects, the pair of facing side portions of the stopper member may have no partial recesses in the circumferential direction of the stopper member.

According to the vibration damping device constructed according to this aspect, since the pair of facing side portions are not formed with partial recesses, a large effective area of a stopper surface formed by the pair of facing side portions is ensured, and high load resistance against a stopper load is realized. In addition, since there is no sudden change in a cross-sectional shape of the pair of facing side portions, cracks caused by stress concentration when the stopper load is applied are less likely to occur.

According to a sixth aspect, in the vibration damping device described in any one of the first to fifth aspects, the lip-shaped part may extend continuously in the axial direction.

According to the vibration damping device constructed according to this aspect, it is possible to set a high deformation rigidity for the lip-shaped part with respect to an input in the axial direction while setting a spring in the protruding direction of the lip-shaped part to be soft. Therefore, in the vibration damping device with the stopper member, it is possible to effectively prevent coming-out in the axial direction while setting soft spring properties in the direction perpendicular to the axis.

According to a seventh aspect, in the vibration damping device described in any one of the first to sixth aspects, an overlap allowance of the retaining part of the lip-shaped part with respect to a wall portion of the accommodation recess when seen in the axial direction may be set within a range of 70% to 100% of a protrusion height of the lip-shaped part.

According to the vibration damping device constructed according to this aspect, it is possible to effectively prevent the stopper member from coming out of the accommodation recess due to the contact of the lip-shaped part with the retaining part while making it easy to insert the lip-shaped part over the retaining part to the inward side.

According to the disclosure, in a vibration damping device with a separate stopper member, it is possible to stably hold the separate stopper member in the accommodation recess even before mounting in a vehicle or the like while controlling the influence of the stopper member on the vibration damping performance.

Hereinafter, embodiments of the disclosure will be described with reference to the drawings.

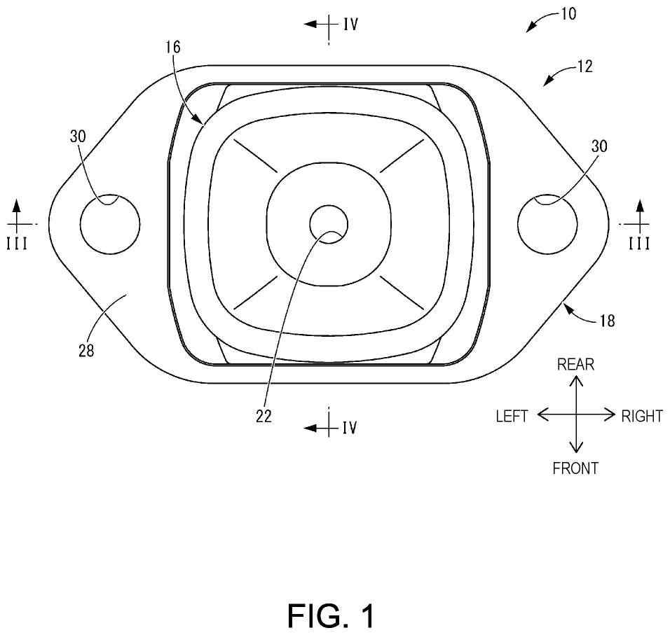

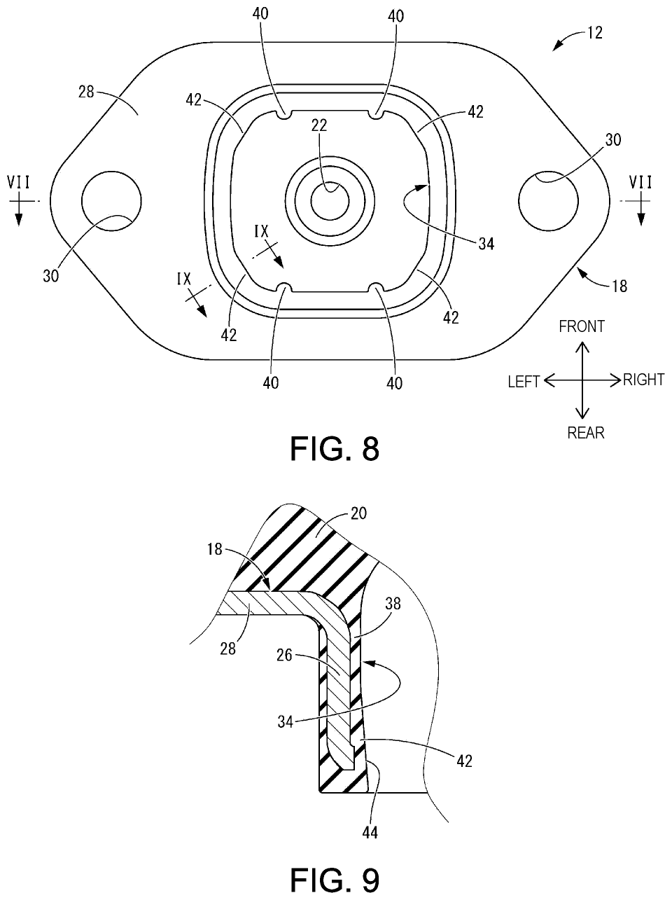

FIGS. 1 to 4 show an engine mount 10 for an automobile as a first embodiment of a vibration damping device constructed according to the disclosure. The engine mount 10 has a structure in which a stopper member 14 is mounted on a mount main body 12 as a vibration damping device main body. As shown in FIGS. 5 to 8, the mount main body 12 has a structure in which a first mounting member 16 and a second mounting member 18 are connected by a main rubber elastic body 20. In the following description, in principle, the up-down direction refers to the up-down direction in FIG. 3 which is a direction of a central axis of a mount, the front-rear direction refers to the up-down direction in FIG. 1, and the left-right direction refers to the left-right direction in FIG. 1. The directions of the engine mount 10 described above do not necessarily match directions of a vehicle in which the engine mount 10 is mounted.

The first mounting member 16 has a substantially quadrilateral shape with rounded corners when seen in an axial direction, is a highly rigid member made of a plate material such as iron or an aluminum alloy, has an inner circumferential end portion and an outer circumferential end portion each extending in a direction substantially perpendicular to the axis, and has a tapered shape in which an intermediate portion in the direction perpendicular to the axis is inclined upward toward the outer circumference. A circular bolt insertion hole 22 penetrates in the up-down direction and is formed in a central portion of the first mounting member 16. For example, as shown in FIG. 3, the first mounting member 16 is mounted on the power unit side by inserting a rod member 24, which is a member on the power unit side, into the bolt insertion hole 22 and bolt-fixing the rod member 24.

The second mounting member 18 integrally includes a tubular part 26 which is a highly rigid member made of a metal or the like similar to the first mounting member 16 and extends in the axial direction with a substantially quadrilateral cross section having rounded corner portions in an arc shape, and a flange part 28 that extends outward from an upper end of the tubular part 26 in the direction perpendicular to the axis. Both left and right side portions of the flange part 28 protrude farther toward the outer circumference than both front and rear side portions, and bolt holes 30 are formed through the left and right side portions that protrude farther. The second mounting member 18 is mounted on the vehicle body side by having the flange part 28 overlapped with a mounting part 32 of the vehicle body and bolt-fixed by using the bolt holes 30 and 30.

Then, the first mounting member 16 is disposed to be spaced apart above the second mounting member 18, and the first mounting member 16 and the second mounting member 18 are elastically connected by the main rubber elastic body 20. The main rubber elastic body 20 has a substantially truncated quadrangular pyramid shape with rounded corner portions, and an end portion thereof on the small diameter side is vulcanized and bonded to a lower surface of the first mounting member 16, while an end portion thereof on the large diameter side is vulcanized and bonded to the tubular part 26 and the flange part 28 of the second mounting member 18. The main rubber elastic body 20 is formed as an integrally vulcanized and molded product including the first mounting member 16 and the second mounting member 18.

A recess that opens downward is formed in the main rubber elastic body 20 and opens downward through the tubular part 26 of the second mounting member 18. Thus, an accommodation recess 34 having a substantially quadrilateral shape when seen in the axial direction is formed on the inner circumferential side of the tubular part 26 so as to open downward in the axial direction. An outer circumferential portion of an upper bottom wall of the accommodation recess 34 is made deformable by the main rubber elastic body 20 alone, one side of each of the first mounting member 16 and the second mounting member 18 is fixed to an inner circumferential portion and a circumferential wall of the upper bottom wall, and deformation of the inner circumferential portion and the circumferential wall of the upper bottom wall is limited.

In the present embodiment, the main rubber elastic body 20 is not fixed to the central portion of the first mounting member 16, and the bolt insertion hole 22 of the first mounting member 16 and a circumferential portion thereof are exposed to the accommodation recess 34 through a center hole of the main rubber elastic body 20. Thus, the rod member 24 inserted into the accommodation recess 34 from below has a threaded tip end portion inserted through the bolt insertion hole 22 of the first mounting member 16, and is configured such that a step provided below the insertion portion into the bolt insertion hole 22 is made to abut on a circumferential edge portion of the bolt insertion hole 22 in the first mounting member 16 from below. Then, by screwing a nut 36 to the tip end portion, the first mounting member 16 is sandwiched between the step of the rod member 24 and the nut 36, and the first mounting member 16 and the rod member 24 are positioned in the axial direction and fixed to each other.

A lower portion of the main rubber elastic body 20 is formed into a thin tubular coating rubber layer 38 that covers an inner circumferential surface of the tubular part 26 of the second mounting member 18 by forming the accommodation recess 34. The coating rubber layer 38 is formed on the inner circumferential surface of the tubular part 26 of the second mounting member 18 and constitutes an inner surface of the circumferential wall of the accommodation recess 34. The main rubber elastic body 20 of the present embodiment also covers an outer circumferential surface and a lower surface of the tubular part 26, and the portion covering the outer circumferential surface and the lower surface of the tubular part 26 is integrally continuous with the coating rubber layer 38.

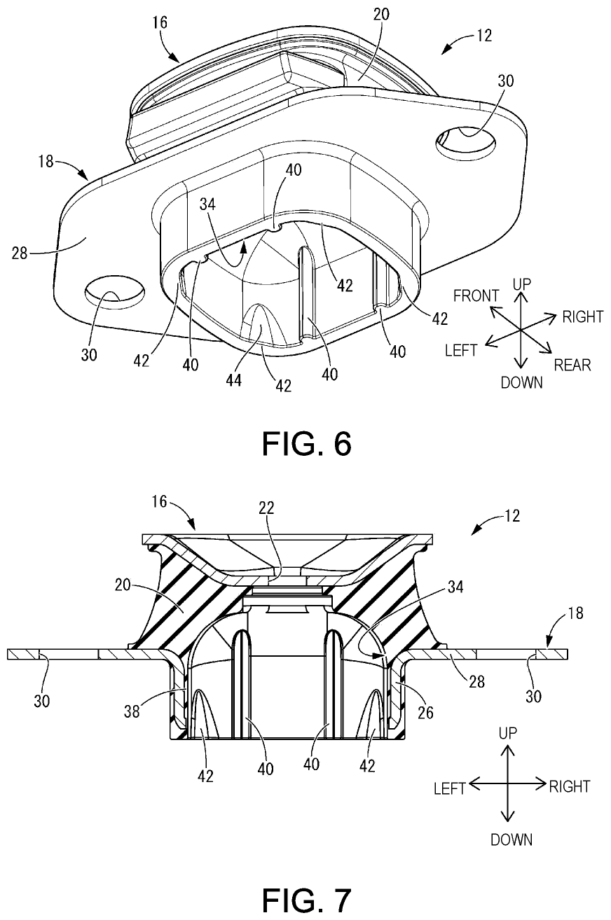

A guide ridge 40 is provided on the inner surface of the circumferential wall of the accommodation recess 34 formed by the main rubber elastic body 20. As shown in FIGS. 6 to 8, the guide ridge 40 extends, with a substantially constant semicircular cross section, from an open end of the accommodation recess 34 in the axial direction, and is formed as a pair of the guide ridges 40 spaced apart from each other in a circumferential direction (the left-right direction) on both front and rear inner surfaces of the circumferential wall of the accommodation recess 34. The pair of guide ridges 40 and 40 located on the front side are formed apart from each other by a distance corresponding to a width dimension of a front guide protrusion 48 of the stopper member 14 which will be described below. Similarly, a pair of guide ridges 40 and 40 located on the rear side are formed apart from each other by a distance corresponding to a width dimension of a rear guide protrusion 48 of the stopper member 14 which will be described below.

As shown in FIGS. 6 to 8, retaining parts 42 are provided at four corner portions of the circumferential wall in the opening of the accommodation recess 34. The retaining parts 42 are formed in a built-up shape at the four corner portions of the accommodation recess 34 and protrude toward the inner circumference, and the inner circumferential surface is formed by a tapered surface 44. As also shown in FIG. 9, the tapered surface 44 is inclined inwardly toward the opening side, and a radial thickness of the retaining part 42 having the tapered surface 44 on the inner circumference gradually increases downward toward the opening side of the accommodation recess 34. An inner diameter dimension at the four corner portions of the accommodation recess 34 is formed to be smaller at a portion at which the retaining part 42 is formed than at a portion that is deviated inward from the retaining part 42. In addition, a thickness dimension of the circumferential wall at the four corner portions of the accommodation recess 34 is made larger at a portion where the retaining part 42 is formed than at the portion that is deviated inward from the retaining part 42.

In the retaining part 42 having the tapered surface 44, an edge (a base end) on the upper bottom side (the inward side) of the accommodation recess 34 is located on the inner circumferential surface of the tubular part 26 of the second mounting member 18, and an edge (a tip end) on the opening side of the accommodation recess 34 extends axially outward (downward) further than the tubular part 26. As a result, a base end portion of the retaining part 42 is restricted by the tubular part 26 such that elastic deformation thereof toward the outer circumference side is limited and elastic deformation of a tip end portion toward the outer circumference side is permitted.

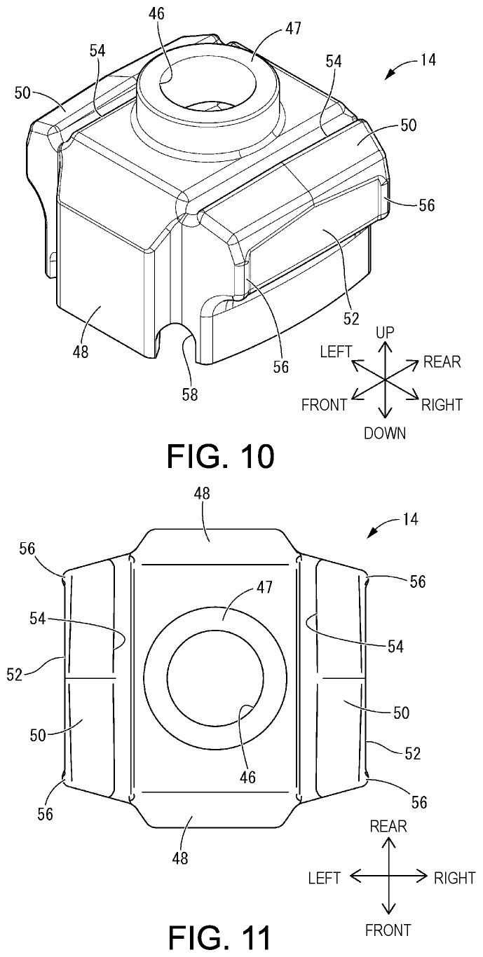

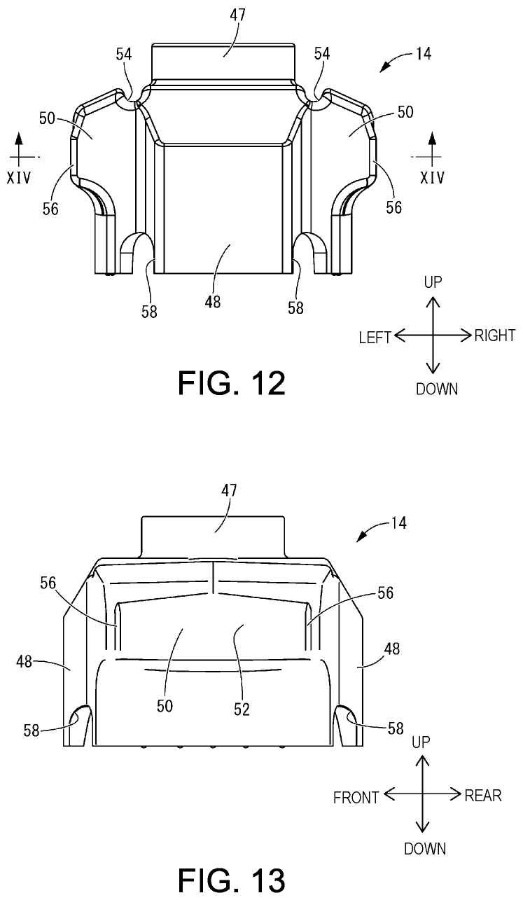

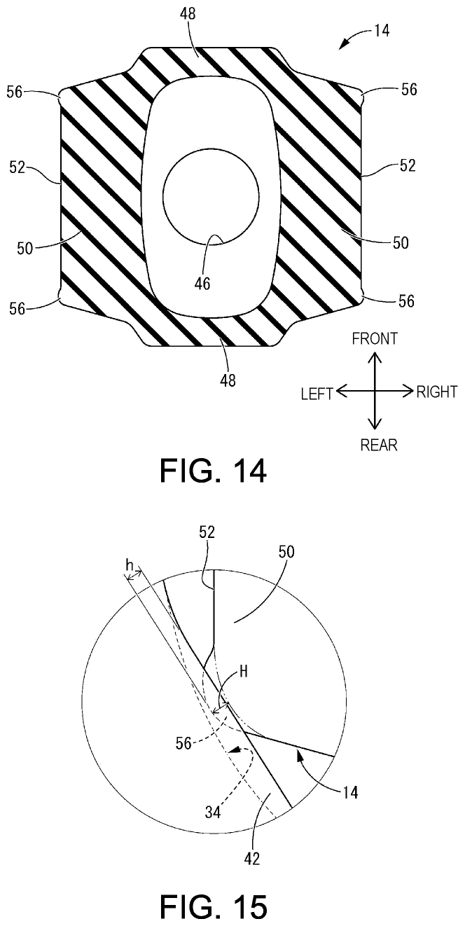

The separate stopper member 14 is mounted on the mount main body 12. As shown in FIGS. 10 to 14, the stopper member 14 is integrally made of a rubber elastic body as a whole, and has a substantially inverted quadrilateral tubular shape with a bottom. The stopper member 14 is formed with a rod insertion hole 46 penetrating an upper bottom wall in the up-down direction, and the rod member 24 can be inserted through the rod insertion hole 46. The stopper member 14 has a cylindrical part 47 protruding upward, and the rod insertion hole 46 is configured to include an inner cavity of the cylindrical part 47. The stopper member may be made of an elastic body such as rubber or elastomer, but for example, a reinforcing material made of a metal or a hard synthetic resin may be embedded inside the elastic body, or the entire stopper member may be hard.

The stopper member 14 is provided with a pair of guide protrusions 48 and 48. The guide protrusions 48 are provided on both front and rear sides of the stopper member 14 and are continuous in the axial direction with a predetermined width in the circumferential direction (the left-right direction). Upper end surfaces of the guide protrusions 48 are tapered to be inclined downward toward the front-rear outward sides. The front and rear outer surfaces of the guide protrusions 48 have a planar shape that extends to be substantially orthogonal to the front-rear direction. The guide protrusions 48 and 48 form a pair of front and rear facing side portions on the outer circumferential surface of the stopper member 14.

Stopper protrusions 50 and 50 that protrude toward both the left and right sides are formed on an upper portion of the stopper member 14. An upper surface of the stopper protrusion 50 is an inclined surface that is inclined downward toward a protruding tip end, a lower surface thereof is an inclined surface that is inclined upward toward the protruding tip end, and the stopper protrusion 50 has a tapered shape that narrows toward the protruding tip end in the up-down direction. The protruding tip end of the stopper protrusion 50 has a planar intermediate tip end surface 52 that extends to be substantially orthogonal to the left-right direction. The intermediate tip end surface 52 constitutes facing side portions located on both left and right sides of the outer circumferential surface of the upper portion of the stopper member 14. The intermediate tip end surface 52 is generally planar as a whole, and has no partial recesses or protrusions. A recessed groove 54 that opens to an upper surface and extends continuously over the entire length in the front-rear direction is formed in the base end portion of the stopper protrusion 50. The recessed groove 54 of the present embodiment extends linearly with a substantially constant semicircular cross section.

As shown in FIGS. 10, 11, 14, and the like, lip-shaped parts 56 are formed to protrude from front and rear end portions of a tip end surface of the stopper protrusion 50. The respective lip-shaped parts 56 protrude toward the outer circumference and are formed integrally with corner portions of the upper portion of the stopper member 14 constituted by the stopper protrusions 50 and 50. The lip-shaped part 56 of the present embodiment extends continuously in the axial direction and extends linearly in the axial direction. The lip-shaped part 56 may have a tapered shape in which a cross-sectional area thereof decreases toward the protruding tip end, and in the present embodiment, since a cross-sectional shape in the direction perpendicular to the axis is a substantially semicircular cross section, it narrows in the circumferential direction toward the protruding tip end side. The lip-shaped part 56 of the present embodiment protrudes outward on both sides in the left-right direction, and an outer end surface in the front-rear direction does not protrude outwardly in the front-rear direction with respect to the outer end surface in the front-rear direction of the stopper protrusion 50. An upper surface of the lip-shaped part 56 is formed as an inclined surface that is continuous with the upper surface of the stopper protrusion 50 and is inclined downward toward the left and right outward sides. The intermediate tip end surface 52, which is a protruding tip end surface of the stopper protrusion 50, is provided between the lip-shaped parts 56 and 56 protruding toward both the front and rear end portions of the stopper protrusion 50 in the front-rear direction.

In the stopper member 14 of the present embodiment, a main body portion excluding the guide protrusion 48 and the stopper protrusion 50 has a substantially rectangular outer shape when seen in the axial direction, and the pair of guide protrusions 48 and 48 are provided at the facing side portions in a longitudinal direction, and the pair of stopper protrusions 50 and 50 are provided on the facing side portions in a transverse direction. A protrusion dimension of the stopper protrusion 50 is larger than a protrusion dimension of the guide protrusion 48, and the stopper member 14 is thicker in the left-right direction in which the stopper protrusion 50 is provided than in the front-rear direction in which the guide protrusion 48 is provided.

A notch 58 that opens downward is formed at a lower end portion of each corner portion of the main body portion of the stopper member 14. Due to the notch 58 being formed, it is possible to reduce strain and to block transmission of stress in a lower portion of the stopper member 14 which is made thin. The notch 58 of the present embodiment has a smoothly curved inner surface so that concentration of stress on the inner surface of the notch 58 is relieved when the stopper member 14 is deformed.

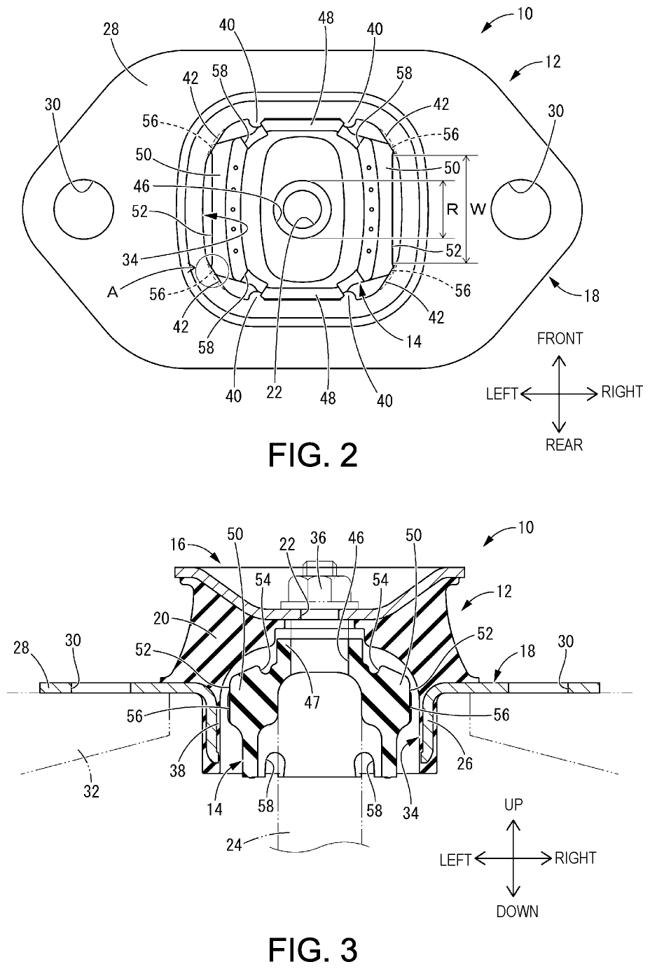

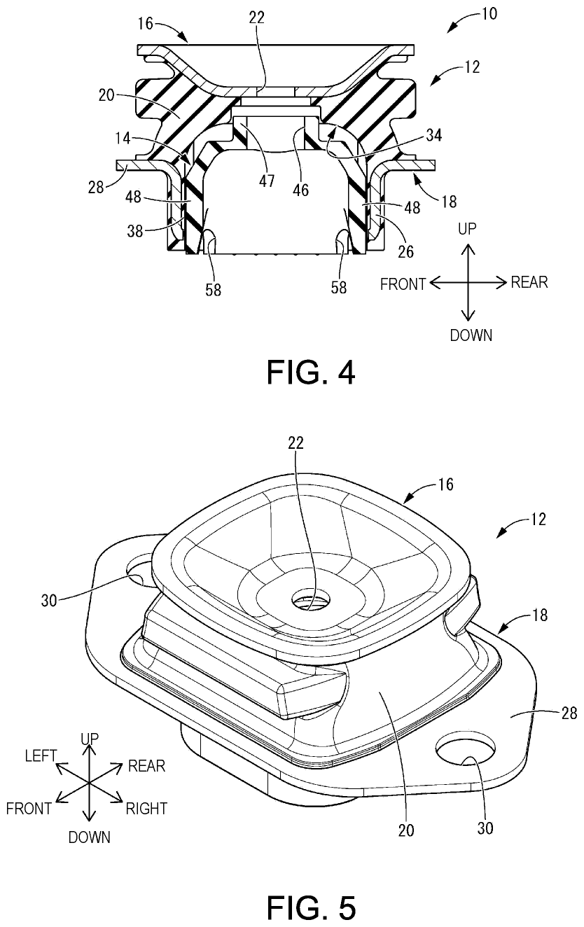

The stopper member 14 having such a structure is accommodated by being inserted into the accommodation recess 34 of the mount main body 12 from below. Since a position of the stopper member 14 in the left-right direction with respect to the accommodation recess 34 is defined by inserting the guide protrusion 48 between the guide ridges 40 and 40 protruding from the inner circumferential surface of the accommodation recess 34, and the stopper member 14 is axially guided by the guide ridges 40 and 40, proper insertion into the accommodation recess 34 is facilitated. As shown in FIGS. 2 and 4, the guide protrusion 48 of the stopper member 14 is superimposed on the inner surface of the circumferential wall of the accommodation recess 34 with substantially no gap between the guide ridges 40 and 40 adjacent in the left-right direction, and may be in contact with the inner surface of the circumferential wall of the accommodation recess 34.

The respective lip-shaped parts 56 provided on the corners of the stopper member 14 are located beyond the respective retaining parts 42 provided at the four corners of the opening of the accommodation recess 34 and is located in the accommodation recess 34 further inward than the retaining part 42, and the stopper protrusions 50 and 50 are accommodated in the accommodation recess 34 further inward than the retaining part 42. Thus, as shown in FIGS. 2 and 15, the lip-shaped part 56 overlaps the retaining part 42 in axial projection. The lip-shaped part 56 may entirely or partially overlap the retaining part 42 in the axial direction. An overlap allowance h (refer to FIG. 15) of the lip-shaped part 56 with respect to the retaining part 42 when seen in the axial direction may be within a range of 70% to 100% of a maximum protrusion height H (refer to FIG. 15) of the lip-shaped part 56, and may also be within a range of 80% to 90%. In FIG. 15, a boundary between the stopper protrusion 50 and the lip-shaped part 56 is imaginary and indicated by a two-dot chain line. As shown in FIG. 15, the stopper protrusion 50 is separated from the retaining part 42 toward the inner circumferential side without overlapping in the axial direction, and only the lip-shaped part 56 overlaps the retaining part 42 in the axial direction.

Since the upper surface of the lip-shaped part 56 of the present embodiment is formed as an inclined surface that is continuous with the upper surface of the stopper protrusion 50, the lip-shaped part 56 easily climbs over the retaining part 42 having the tapered surface 44 when the stopper member 14 is inserted into the accommodation recess 34.

In the stopper protrusion 50 which is inserted further inward than the retaining part 42 in the accommodation recess 34, the intermediate tip end surface 52 between the lip-shaped parts 56 and 56 provided at both front and rear ends is spaced apart inwardly in the left-right direction from the inner circumferential surface of the accommodation recess 34. Further, both front and rear side surfaces of the stopper protrusion 50 are spaced apart inwardly in the front-rear direction from the inner circumferential surface of the accommodation recess 34. The intermediate tip end surface 52 located between the lip-shaped parts 56 is spaced inwardly in the left-right direction from the inner circumferential surface of the accommodation recess 34 in a region extending to both the front and rear outer sides of the rod insertion hole 46. In short, as shown in FIG. 2, a front-rear width dimension W of the region in which the intermediate tip end surface 52 is spaced inwardly in the left-right direction from the inner circumferential surface of the accommodation recess 34 is set to be larger than a diameter dimension R of the rod insertion hole 46 in the front-rear direction.

A protruding tip end of the lip-shaped part 56 may be in contact with or separated from the inner circumferential surface of the accommodation recess 34 inward with respect to the retaining part 42. When the protruding tip end of the lip-shaped part 56 is in contact with the inner circumferential surface of the accommodation recess 34, a position of the stopper member 14 relative to the mount main body 12 in the direction perpendicular to the axis can be more stably defined. When the protruding tip end of the lip-shaped part 56 is spaced apart from the inner circumferential surface of the accommodation recess 34, the influence of the stopper member 14 on a spring in the left-right direction, which will be described below, is further reduced, and thus it becomes easier to achieve softer spring properties. In the present embodiment, the lip-shaped part 56 is spaced apart from the inner circumferential surface of the accommodation recess 34 toward the inner circumferential side inward with respect to the retaining part 42, and the entire stopper protrusion 50 including the lip-shaped part 56 and the front and rear side surfaces is spaced apart from the inner circumferential surface of the accommodation recess 34.

The engine mount 10 constituted by combining the mount main body 12 and the separate stopper member 14 needs to prevent the stopper member 14 from slipping out of the accommodation recess 34 of the mount main body 12 and falling off in a single unit state before it is mounted in the vehicle. Here, in the engine mount 10, since the lip-shaped part 56 of the stopper member 14 axially overlaps the retaining part 42 provided at the opening of the accommodation recess 34, the stopper member 14 is prevented from falling off from the accommodation recess 34 by locking the lip-shaped part 56 to the retaining part 42 in the axial direction. Therefore, the mount main body 12 and the stopper member 14 can be handled integrally, and storage and transportation of the engine mount 10 are facilitated.

In the engine mount 10, the retaining structure for preventing the stopper member 14 from falling off from the mount main body 12 is provided at the four corner portions of the stopper member 14 and the accommodation recess 34. Thus, a stable retaining effect can be obtained without making a work of inserting the stopper member 14 into the accommodation recess 34 excessively difficult as compared with a case in which the retaining structure by locking in the axial direction is provided over the entire circumference.

Since the overlap allowance h of the lip-shaped part 56 with respect to the retaining part 42 when seen in the axial direction is set within the range of 70% to 100% of the maximum protrusion height H of the lip-shaped part 56, when the stopper member 14 is inserted into the accommodation recess 34 and is assembled to the mount main body 12, the lip-shaped part 56 easily climbs over the retaining part 42, and it is possible to effectively prevent the stopper member 14 from coming out of the accommodation recess 34 due to the contact between the lip-shaped part 56 and the retaining part 42.

When the engine mount 10 is mounted in a vehicle and a large load is input in the left-right direction (the front-rear direction of the vehicle), the stopper protrusion 50 of the stopper member 14 comes into contact with the circumferential wall of the accommodation recess 34 of the mount main body 12, and thus a stopper action limiting an amount of relative displacement between the first mounting member 16 and the second mounting member 18 in the left-right direction is exerted. Thus, excessive deformation of the main rubber elastic body 20 connecting the first mounting member 16 and the second mounting member 18 is prevented, and durability of the main rubber elastic body 20 is improved. The large load in the left-right direction can be input to the engine mount 10 due to, for example, sudden acceleration and deceleration of the vehicle.

Since the stopper protrusion 50 preferentially comes into contact with the circumferential wall of the accommodation recess 34 at the lip-shaped part 56 that protrudes outwardly in the left-right direction, and then an amount of compressive deformation of the lip-shaped part 56 becomes sufficiently large, the intermediate tip end surface 52 of the stopper protrusion 50 comes into contact with the circumferential wall of the accommodation recess 34 between the lip-shaped parts 56 and 56. In this way, the stopper protrusion 50 comes into contact with the circumferential wall of the accommodation recess 34 step by step at a portion in which the lip-shaped part 56 is formed and a portion outside the lip-shaped part 56, and thus an impact caused by the contact between the stopper protrusion 50 and the circumferential wall of the accommodation recess 34 is mitigated, and an influence on riding comfort and the like is curbed.

The front and rear side surfaces of the stopper protrusion 50 are spaced apart inwardly in the front-rear direction from the inner circumferential surface of the accommodation recess 34 and are free surfaces that are not restrained by the inner circumferential surface of the accommodation recess 34. Therefore, when the left and right tip ends of the stopper protrusion 50 come into contact with the circumferential wall of the accommodation recess 34 and the stopper protrusion 50 is compressed in the left-right direction, since the stopper protrusion 50 is allowed to expand and deform on the front and rear side surfaces, relatively soft spring properties are realized.

On the other hand, when a large load in the front-rear direction (the left-right direction of the vehicle) is input to the engine mount 10 mounted in the vehicle, the guide protrusion 48 of the stopper member 14 is pressed against the circumferential wall of the accommodation recess 34 of the mount main body 12 to be compressed by, and thus the stopper action limiting the amount of relative displacement in the front-rear direction between the first mounting member 16 and the second mounting member 18 is exerted. Thus, excessive deformation of the main rubber elastic body 20 connecting the first mounting member 16 and the second mounting member 18 is prevented, and the durability of the main rubber elastic body 20 is improved. In the present embodiment, since the guide protrusion 48 is in contact with the inner circumferential surface of the accommodation recess 34 in advance, the stopper action due to the compression of the guide protrusion 48 is quickly exerted.

Further, when small-amplitude vibration such as idling vibration is input to the engine mount 10 in the left-right direction, a vibration damping effect (a vibration-isolating action) due to low dynamic spring properties is effectively exerted. That is, the intermediate tip end surface 52 of the stopper protrusion 50 of the stopper member 14 is spaced apart in the left-right direction from the circumferential wall of the accommodation recess 34 between the front and rear lip-shaped parts 56 and 56 provided at both front and rear ends. Therefore, when the small-amplitude vibration is input, the influence of the stopper member 14 on the spring properties of the engine mount 10 in the left-right direction is reduced, and the low dynamic spring properties of the engine mount 10 in the left-right direction are easily realized.

In the present embodiment, the intermediate tip end surface 52 located between the front and rear lip-shaped parts 56 and 56 is spaced apart inwardly in the left-right direction from the inner circumferential surface of the accommodation recess 34 in a region extending to both the front and rear outer sides of the rod insertion hole 46. In this way, since a spaced region between the stopper protrusion 50 and the inner circumferential surface of the accommodation recess 34 is secured over a wide range in the circumferential direction, the stopper member 14 is less likely to affect the spring properties of the engine mount 10 when the small-amplitude vibration is input in the left-right direction. In the present embodiment, since the entire stopper protrusion 50 including the lip-shaped part 56 and the front and rear side surfaces is separated inwardly from the inner circumferential surface of the accommodation recess 34, the spring of the stopper member 14 is less likely to affect when the small-amplitude vibration is input in the left-right direction, and soft spring properties are realized.

A facing gap between the intermediate tip end surface 52 of the stopper protrusion 50 and the inner circumferential surface of the accommodation recess 34 is set by setting a magnitude of curvature of the intermediate tip end surface 52 of the stopper protrusion 50 smaller than a magnitude of curvature of a portion of the inner circumferential surface of the accommodation recess 34 facing the intermediate tip end surface 52. In particular, in the present embodiment, the intermediate tip end surface 52 is substantially planar, and the portion of the inner circumferential surface of the accommodation recess 34 facing the intermediate tip end surface 52 is formed of a circumferentially curved surface that is concave toward the inner circumference. Thus, due to a difference in shape between the intermediate tip end surface 52 and the inner circumferential surface of the accommodation recess 34, the intermediate tip end surface 52 can be easily spaced apart inwardly in the left-right direction from the inner circumferential surface of the accommodation recess 34.

In the engine mount 10 of the present embodiment, since the guide protrusions 48 and 48 of the stopper member 14 are close to or in contact with the inner surface of the circumferential wall of the accommodation recess 34, the spring properties of the engine mount 10 are easily affected by the stopper member 14 even when the small-amplitude vibration is input in the front-rear direction. Therefore, it is possible to set hard spring properties in the front-rear direction of the engine mount 10 using the spring of the stopper member 14, and thus it is possible to realize improvement of steering stability of the vehicle, for example. In particular, in the present embodiment, since the protruding tip end portion of the guide protrusion 48 is inserted into a space between the left and right guide ridges 40 and 40 in a contact state, the deformation of the protruding tip end portion of the guide protrusion 48 is restrained by the guide ridges 40 and 40, and thus the relatively hard spring properties can be easily obtained.

In FIG. 3, the rod member 24 on the power unit side and the mounting part 32 on the vehicle body side of the engine mount 10 in the single unit state are virtually shown by two-dot chain lines in order to facilitate understanding of how the engine mount 10 is mounted in the vehicle, but in an actual vehicle mounting state, since a shared support load of the power unit acts downward, the first mounting member 16 and the stopper member 14 are displaced downward relative to the second mounting member 18. Therefore, in a state in which the engine mount 10 is mounted in the vehicle, the stopper protrusions 50 and 50 of the stopper member 14 are disposed to face the tubular part 26 of the second mounting member 18 in the left-right direction, and a portion on which a stopper load in the left-right direction acts due to the contact of the stopper protrusions 50 and 50 is constituted by a portion of the circumferential wall of the accommodation recess 34 reinforced by the tubular part 26. Therefore, deformation of the circumferential wall of the accommodation recess 34 due to the action of the stopper load is reduced.

Although the embodiments of the disclosure have been described in detail above, the disclosure is not limited by the specific descriptions. For example, the retaining part 42 does not necessarily have to be formed only at the four corner portions, and may be formed at portions corresponding to the lip-shaped parts 56. Specifically, for example, the retaining part 42 may be provided in an annular shape continuously over the entire circumference.

The retaining part 42 is provided by making the coating rubber layer 38 forming the inner surface of the circumferential wall of the accommodation recess 34 thicker toward the opening side of the accommodation recess 34 as in the above-described embodiment, and can be provided, for example, by tapering the lower portion of the tubular part 26 so that a diameter thereof decreases downward. Although the inner circumferential surface of the retaining part 42 may be a tapered surface 44 that is inclined inwardly toward the opening side of the accommodation recess 34, for example, it may be configured with a non-inclined surface extending in the axial direction, or may be configured with a reverse tapered surface that is inclined outward toward the opening side of the accommodation recess 34.

The lip-shaped part 56 may not necessarily be formed only on the upper portion of the stopper member 14, and may be formed over the entire length of the outer circumferential surface of the stopper member 14 in the axial direction, for example. In this case, the entirety of the stopper member 14 in the axial direction is inserted into the accommodation recess 34 further inward than the retaining part 42, and thus the lip-shaped part 56 is disposed further inward than the retaining part 42.

For example, the lip-shaped parts 56 may be formed to protrude in a diagonal direction of the stopper member 14 having a quadrilateral outer shape, or may protrude in the front-rear direction from the corner portions of the stopper member 14. A cross-sectional shape of the lip-shaped part 56 is not particularly limited. The lip-shaped part 56 may not necessarily have a shape extending in the axial direction, and may have a spot-like protrusion shape, for example.

The intermediate tip end surface 52 located between the lip-shaped parts 56 and 56 is not limited to a planar surface, and may be, for example, a curved surface that is concave or convex toward the outer circumference. In addition, the inner circumferential surface of the accommodation recess 34 facing the intermediate tip end surface 52 is not limited to a curved surface that is concave toward the inner circumference, and may be, for example, a planar surface or a curved surface that is convex toward the inner circumference. In any case, the intermediate tip end surface 52 and the inner circumferential surface of the accommodation recess 34 facing it are disposed to be spaced apart from each other to a region deviated from the rod insertion hole 46 outwardly in the front-rear direction due to different curvatures, different shapes, different front and rear diameter dimensions, and the like.

The accommodation recess 34 is not limited to a quadrilateral shape when seen in the axial direction, and may be, for example, a circle or a polygon other than the quadrilateral shape.

The scope of application of the disclosure is not limited to the engine mount, but can also be applied to vibration damping devices used as sub-frame mounts, body mounts, differential mounts, and the like. Further, the disclosure is applicable not only to the vibration damping devices for automobiles, but also to vibration damping devices used for motorcycles, railroad vehicles, industrial vehicles, and the like.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vibration damping device in which a first mounting member and a second mounting member are connected by a main rubber elastic body, and a separate stopper member is accommodated in an accommodation recess that opens in an axial direction in an inner circumference of a tubular part of the second mounting member, wherein
a retaining part that protrudes toward an inner circumference is provided at an opening of the accommodation recess,
an outer shape of the stopper member is substantially quadrilateral, and lip-shaped parts that protrude from corner portions toward an outer circumference are provided at the stopper member,
the lip-shaped part is located further inward than the retaining part in the accommodation recess, and the lip-shaped part overlaps the retaining part in axial projection,
a rod insertion hole through which a rod member fixed to the first mounting member is inserted is formed through the stopper member in the axial direction, and
a pair of facing side portions located on both sides in a direction perpendicular to an axis on an outer circumferential surface of the stopper member are spaced apart from an inner circumferential surface of the accommodation recess toward an inner circumference in a region extending to both outer sides of the rod insertion hole between the lip-shaped parts.

2. The vibration damping device according to claim 1, wherein another pair of facing side portions located between the pair of facing side portions on the outer circumferential surface of the stopper member in a circumferential direction is in contact with the inner circumferential surface of the accommodation recess.

3. The vibration damping device according to claim 1, wherein a magnitude of curvature of the pair of facing side portions of the stopper member is smaller than a magnitude of curvature of a portion of the inner circumferential surface of the accommodation recess that faces the pair of facing side portions.

4. The vibration damping device according to claim 3, wherein
the pair of facing side portions of the stopper member are planar, and
the portion of the inner circumferential surface of the accommodation recess that faces the pair of facing side portions is formed of a curved surface that is concave toward the inner circumference.

5. The vibration damping device according to claim 1, wherein the pair of facing side portions of the stopper member have no partial recesses in the circumferential direction of the stopper member.

6. The vibration damping device according to claim 1, wherein the lip-shaped part extends continuously in the axial direction.

7. The vibration damping device according to claim 1, wherein an overlap allowance of the retaining part of the lip-shaped part with respect to a wall portion of the accommodation recess when seen in the axial direction is set within a range of 70% to 100% of a protrusion height of the lip-shaped part.

8. The vibration damping device according to claim 2, wherein a magnitude of curvature of the pair of facing side portions of the stopper member is smaller than a magnitude of curvature of a portion of the inner circumferential surface of the accommodation recess that faces the pair of facing side portions.

9. The vibration damping device according to claim 8, wherein
the pair of facing side portions of the stopper member are planar, and
the portion of the inner circumferential surface of the accommodation recess that faces the pair of facing side portions is formed of a curved surface that is concave toward the inner circumference.

10. The vibration damping device according to claim 2, wherein the pair of facing side portions of the stopper member have no partial recesses in the circumferential direction of the stopper member.

11. The vibration damping device according to claim 2, wherein the lip-shaped part extends continuously in the axial direction.

12. The vibration damping device according to claim 2, wherein an overlap allowance of the retaining part of the lip-shaped part with respect to a wall portion of the accommodation recess when seen in the axial direction is set within a range of 70% to 100% of a protrusion height of the lip-shaped part.
